(19) United States
(12) Patent Application Publication
(10) Pub. No.: US 2015/0283619 A1
(43) Pub. Date: Oct. 8, 2015

(54) CLAMP WITH INTEGRATED INSERT-RECEIVING POCKET

(71) Applicant: Kennametal India Ltd., Bangalore (IN)

(72) Inventors: Arunachalam Muthuchidambaram, Bangalore (IN); Padmakumar Muthuswamy, Bangalore (IN)

(21) Appl. No.: 14/670,624

(22) Filed: Mar. 27, 2015

(30) Foreign Application Priority Data
Apr. 7, 2014 (IN) 1827/CHE/2014

(51) Int. Cl. B23B 27/16

(52) U.S. Cl. CPC B23B 27/1644; B23B 2205/02; B23B 2205/045; B23B 2205/10; B23B 2205/12

(57) ABSTRACT

A tool holder includes a body having a forward end with a clamp seating surface, and a clamp mounted on the clamp seating surface with an integrated insert-receiving pocket for receiving a cutting insert. The insert-receiving pocket is formed by a pair of side walls formed at an angle with respect to each other, depending on the shape of the cutting insert. A slot is formed in side walls to allow the clamp to act as a cantilevered member when a clamp screw is received in an insert screw, thereby causing the clamp to press against the cutting insert to securely hold the cutting insert in the insert-receiving pocket of the clamp.

### BACKGROUND OF THE INVENTION

1. Field of the Invention

The invention pertains to a tool holder. More particularly, the invention relates to a tool holder having a clamp with an integrated insert-receiving pocket for receiving a cutting insert.

2. Description of Related Art

Typically, tool holder mechanisms utilize an insert-receiving pocket being formed in the body of the tool holder. However, forming the insert-receiving pocket in the body of the tool holder is time consuming and difficult to machine within manufacturing tolerances, thereby increasing the manufacturing cost of the tool holder. Therefore, there is a need to provide a tool holder for clamping an insert that is simple to manufacture and has improved manufacturing tolerances, while requiring fewer components.

### SUMMARY OF THE INVENTION

The problem of improving manufacturing tolerances, while requiring fewer components, is solved by providing a clamp with an integrated insert-receiving pocket.

In one aspect of the invention, a tool holder comprises a body having a forward end with a clamp seating surface, and a clamp mounted on the clamp seating surface and having an integrated insert-receiving pocket for receiving a cutting insert.

In another aspect of the invention, a tool holder comprises a body having a forward end with a clamp seating surface, and a clamp is mounted on the clamp seating surface and has an integrated insert-receiving pocket for receiving a cutting insert. The insert-receiving pocket is formed by a pair of side walls formed at an angle with respect to each other. The clamp further includes a pair of opposing side walls and a slot is formed in the side walls to allow a front portion of the clamp to act as a cantilevered member. The seating surface includes a threaded insert screw-receiving bore for receiving an insert screw and a threaded clamp screw-receiving bore for receiving a first clamp screw. The insert screw-receiving bore is formed at an angle with respect to the insert screw-receiving bore. The clamp includes a screw-receiving bore for receiving a second clamp screw and a clamp screw-receiving bore for receiving the first clamp screw. The second clamp screw is received in the insert screw, thereby causing the front portion of the clamp to press against the cutting insert to securely hold the cutting insert in the insert-receiving pocket of the clamp.

In yet another aspect of the invention, a method of assembling a tool holder comprises:
mounting a clamp with an integrated insert-receiving pocket on a clamp seating surface of a body of the tool holder such that a clamp screw-receiving bore of the clamp is substantially aligned with a clamp screw-receiving bore in the body and a screw-receiving bore in the clamp is substantially aligned with an insert screw-receiving bore in the body;
threading a clamp screw into the clamp screw-receiving bore in the body of the tool holder;
positioning a cutting insert between the clamp seating surface of the body and the clamp such that the cutting insert resides within the insert-receiving pocket of the clamp;
threading an insert screw into the insert screw-receiving bore in the body, thereby causing the cutting insert to be pulled toward the insert-receiving pocket of the clamp; and
threading a clamp screw into the insert screw, thereby causing the clamp to firmly engage the cutting insert and securely holding the cutting insert in the insert-receiving pocket of the clamp.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is an isometric view of an assembled tool holder with a clamp having an integrated insert-receiving pocket according to an embodiment of the invention;

FIG. 2 is a partial isometric exploded view of the tool holder of FIG. 1 according to an embodiment of the invention;

FIG. 3 is a top view of the tool holder of FIG. 1 according to an embodiment of the invention;

FIG. 4 is an isometric view of an insert screw for being threaded into an insert screw-receiving bore of the body of the tool holder;

FIG. 5 is an isometric view of the clamp with an integrated insert-receiving pocket according to an embodiment of the invention;

FIG. 6 is a top view of the clamp of FIG. 5;

FIG. 7 is a side view of the clamp of FIG. 5;

FIG. 8 is a front view of the clamp of FIG. 5;

FIG. 9 is a partial isometric view of the tool holder with the clamp screw being threadingly received in a clamp screw-receiving bore of the clamp and the body of the tool holder according to a method of the invention;

FIG. 10 is a partial isometric view of the cutting insert positioned within the insert-receiving pocket of the clamp according to the method of the invention;

FIG. 11 is a partial isometric view of the tool holder with the insert screw being threadingly received in the insert screw-receiving bore of the body of the tool holder according to the method of the invention; and

FIG. 12 is a partial isometric view of the tool holder with a second clamp screw being threadingly received in the insert screw to cause the clamp to press against to the cutting insert according to the method of the invention.

### DETAILED DESCRIPTION OF THE INVENTION

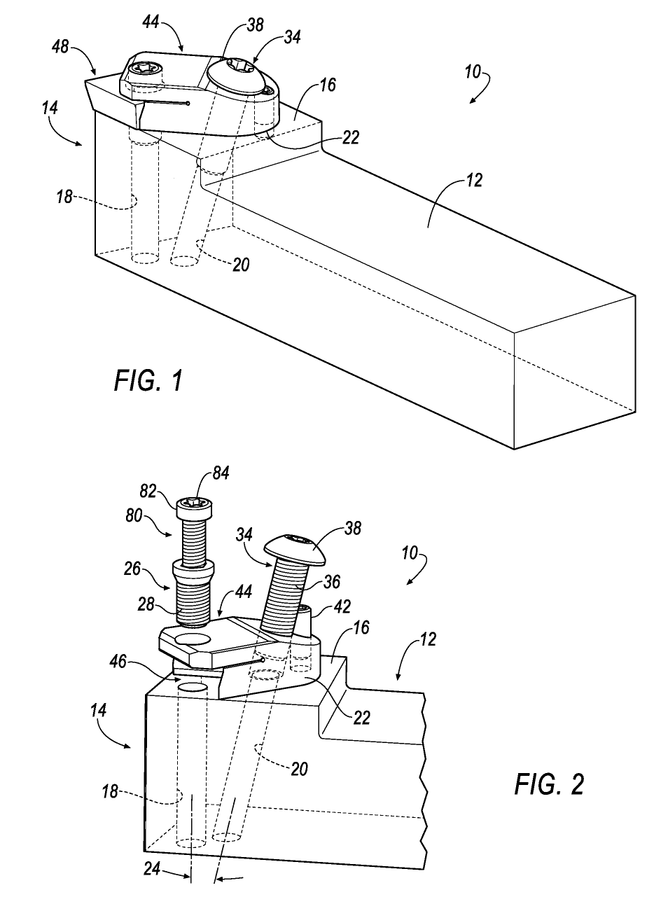

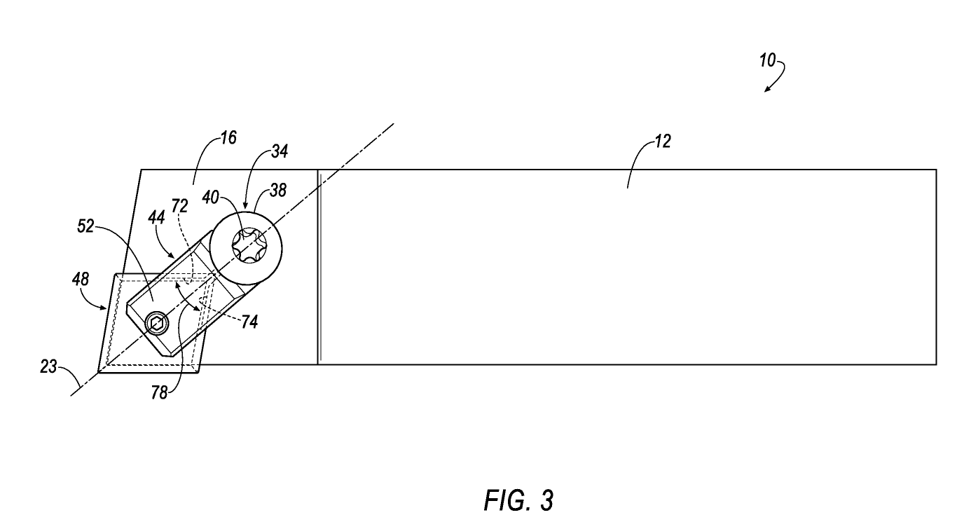

Referring now to FIGS. 1-3, a tool holder 10 is shown according to an embodiment of the invention. The tool holder 10 comprises a tool holder body 12 having a forward end 14 with a substantially planar clamp seating surface 16. In the illustrated embodiment, the clamp seating surface 16 is higher in elevation than the remainder of the body 12. The seating surface 16 includes an insert screw-receiving bore 18, a clamp screw-receiving bore 20 and a pin-receiving bore 22. The insert screw-receiving bore 18 and the clamp-screw receiving bore 20 are threaded, whereas the pin-receiving bore 22 is not threaded. As shown in FIG. 3, the insert screw-receiving bore 18, the clamp screw-receiving bore 20 and the pin-receiving bore 22 are aligned with each other with respect to a plane 23. The insert screw-receiving bore 18 and the clamp screw-receiving bore 20 are formed at an angle 24 with respect to each other. In one embodiment, the pin-receiving bore 22 is formed substantially parallel to the insert screw-receiving bore 18, and therefore is formed at a similar angle as the angle 24 with respect clamp screw-receiving bore 20. In one embodiment, the pin-receiving bore 22 is eliminated.

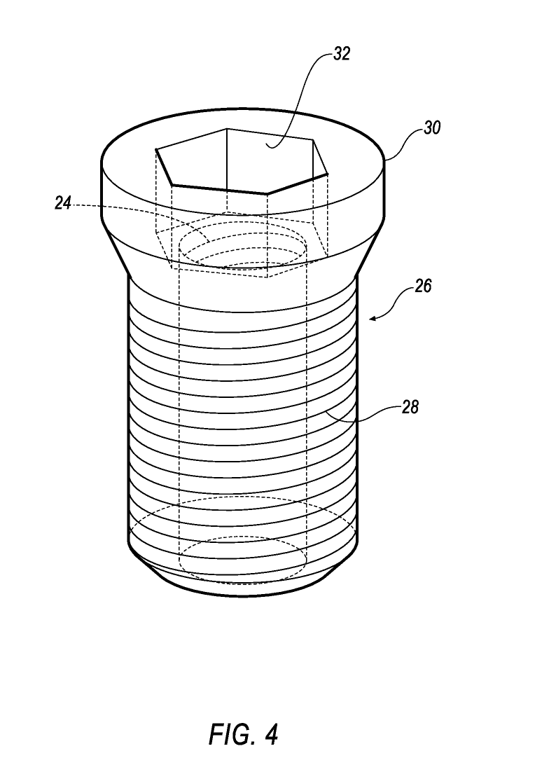

As shown in FIG. 4, the insert screw-receiving bore 18 is capable of receiving an insert screw 26 having external threads 28, internal threads 29, and a head 30 with a recess 32 adapted to receive a tool (not shown). The head 30 has a larger diameter than the threaded portion of the screw 26. In the illustrated embodiment, the recess 32 is hexagonal in shape for receiving an Allen wrench. However, the recess 32 can be any desirable shape capable of receiving any desired tool.

Referring back to FIGS. 1-3, the clamp screw-receiving bore 20 is capable of receiving a clamp screw 34 having external threads 36 and a head 38 with a recess 40 adapted to receive a tool (not shown). In the illustrated embodiment, the recess 40 is star-shaped for receiving a Torx wrench. However, the recess 40 can be any desirable shape capable of receiving any desired tool. The pin-receiving bore 22 is capable of receiving a pin 42, as shown in FIG. 2. In one embodiment, the pin 42 can be press-fit into the pin-receiving bore 22, similar to a dowel. The pin 42 is used to properly locate the clamp 44 on the clamp seating surface 16.

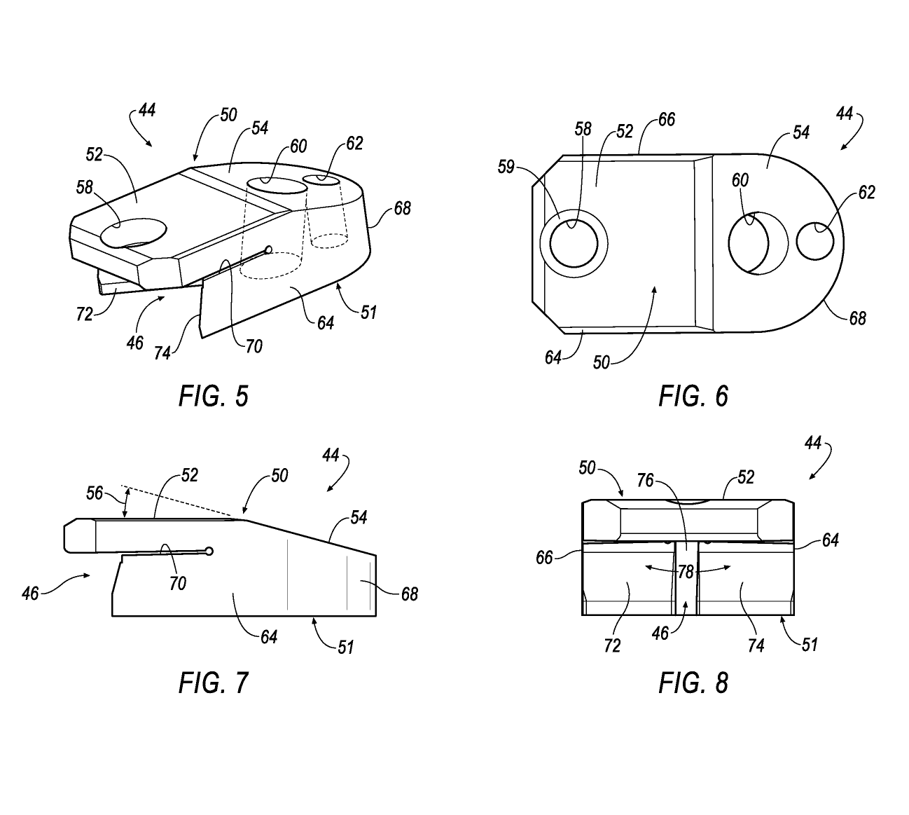

Referring now to FIGS. 5-8, an aspect of the invention is that the tool holder 10 includes a clamp 44 with an integrated insert-receiving pocket 46 for receiving a cutting insert 48 (FIG. 1). The clamp 44 includes a top surface 50 and a bottom surface 51 opposite the top surface 50. The top surface 50 has a front portion 52 and a rear portion 54 formed at an angle 56 with respect to the front portion 52. The angle 56 can be in the range between about five (5) degrees and about forty-five (45) degrees. The front portion 52 includes a screw-receiving bore 58, and the rear portion 54 includes a clamp screw-receiving bore 60 and a pin-receiving bore 62. The clamp screw-receiving bore 60 has a diameter sufficiently large to allow the threaded portion of the clamp screw 34, while allowing the head 38 of the clamp screw 34 to engage the second portion 54 of the clamp 44. The clamp screw-receiving bore 60 is formed at the angle 24 with respect to the screw-receiving bore 60.

When properly located on the clamp seating surface 16 of the body 12, the clamp screw-receiving bore 60 is substantially aligned with the clamp screw-receiving bore 20 and the screw-receiving bore 58 is substantially aligned with the insert screw-receiving bore 18. In addition, the pin-receiving bore 62 is substantially aligned with the pin-receiving bore 22 in the body 12 when the clamp 44 is properly located on the clamp seating surface 16. Thus, both the screw-receiving bore 58 and the pin-receiving bore 62 are used to properly locate the clamp 44 on the clamp seating surface 16 of the body 12.

The clamp 44 includes a pair of opposing side walls 64, 66 and an arcuate-shaped rear wall 68 connecting the side walls 64, 66. A slot 70 is formed in the side walls 64, 66 to allow the front portion 52 to act as a cantilevered member.

The insert-receiving pocket 46 is formed by a pair of side walls 72, 74 and a corner radius 76 therebetween. The corner radius 76 provides clearance for the cutting insert 48. As shown in FIGS. 3 and 8, the side walls 72, 74 are formed at an angle 78 with respect to each other, depending on the shape of the cutting insert 48. It will be appreciated that the angle 78 can be any desired angle for accommodating the corresponding shape of the cutting insert 48. For example, the angle 78 may be about eighty (80) degrees for a diamond-shaped cutting insert 48. In another example, the angle 78 may be ninety (90) degrees for a square-shaped cutting insert 48. In another example, the angle 78 may be sixty (60) degrees for a triangular-shaped cutting insert 48.

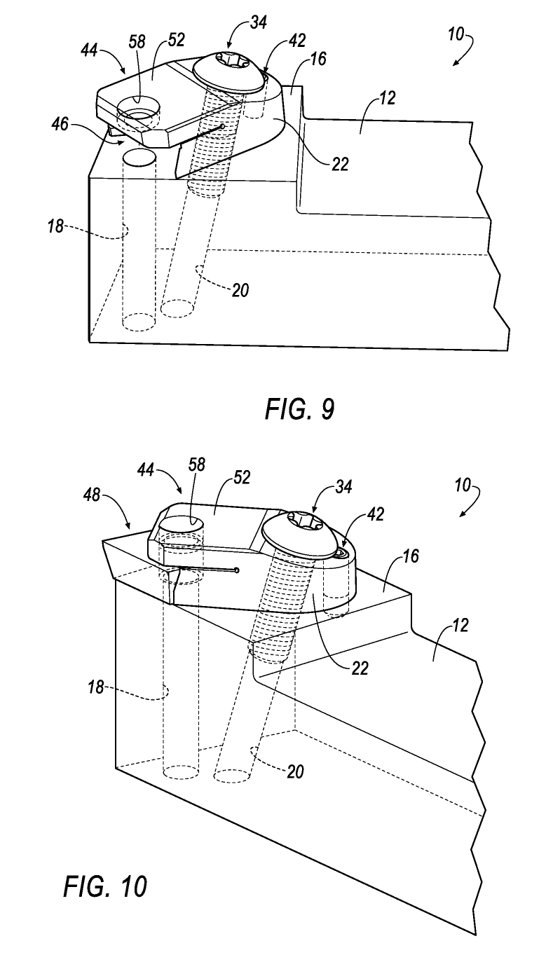

To assemble the tool holder 10, the clamp 44 is mounted on the clamp seating surface 16 of the body 12 such that the clamp screw-receiving bore 60 of the clamp 44 is substantially aligned with the clamp screw-receiving bore 20 in the body 12, as shown in FIG. 9. The clamp screw 34 is then threaded into the clamp screw-receiving bore 20 in the body 12 of the tool holder 10. In addition, the pin 42 is inserted through the pin-receiving bore 62 of the clamp 44 and into the pin-receiving bore 22 of the body 12, if present. At this point, the screw-receiving bore 58 in the clamp 44 is substantially aligned with the insert screw-receiving bore 18 in the body 12.

Next, the cutting insert 48 is positioned between the clamp seating surface 16 of the body 12 and the clamp 44 such that the cutting insert 48 resides within the insert-receiving pocket 46 of the clamp 44, as shown in FIG. 10.

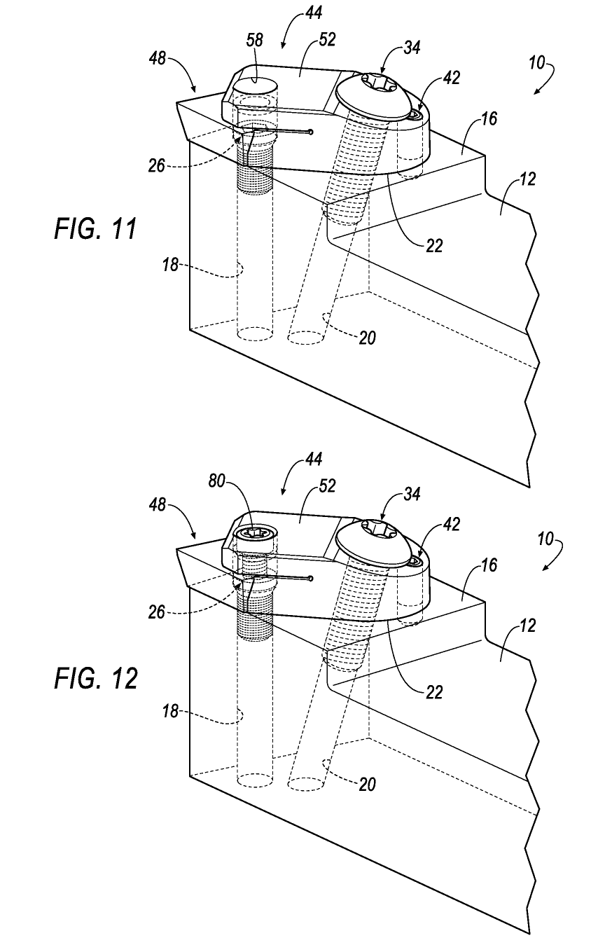

Then, the insert screw 26 is threaded into the insert screw-receiving bore 18 in the body 12, thereby causing the cutting insert 48 to be pulled rearward toward the side walls 72, 74 of the insert-receiving pocket 46 of the clamp 44, as shown in FIG. 11.

It is noted that the internal threads 29 of the insert screw 26 are adapted to receive a clamp screw 80, as shown in FIG. 2. The clamp screw 80 has a head 82 with a larger diameter than the threaded portion of the clamp screw 82. The head 82 has a recess 84 for accommodating a tool (not shown) for threading the clamp screw 80 into the insert screw 26.

Then, the clamp screw 80 is threaded into the insert screw 26. As the clamp screw 80 is threaded into the insert screw 26, the head 82 engages a ledge 59 formed in the screw-receiving bore 58 in the clamp 44 (FIG. 6). As the clamp screw 80 is further threaded into the insert screw 26, the clamp screw 80 causes the front portion 52 that acts as a cantilevered member to firmly engage the cutting insert 48, thereby securely holding the cutting insert 48 in the insert-receiving pocket 46 of the clamp 44, as shown in FIG. 12.

There are several advantages to the clamp 44 with the integrated insert-receiving pocket 46 of the invention. The integrated insert-receiving pocket 46 in the clamp 44 provides for a plain and simple design of the tool holder 10, thereby reducing machining time and cost involved in manufacturing the tool holder 10. The insert-receiving pocket 46 can be easily made by casting or injection molding with very less machining to give the final finish. The lead angle and/or approach angle can be varied by simply changing the location of the clamp screw-receiving bore 20 and the pin-receiving bore 22 in the body 12, depending on whether the tool holder 10 has sufficient clearances under the clamp seating surface 16.

The patents and publications referred to herein are hereby incorporated by reference.

Having described presently preferred embodiments the invention may be otherwise embodied within the scope of the appended claims.

1. A tool holder comprising:
a body having a forward end with a clamp seating surface; and
a clamp mounted on the clamp seating surface and having an integrated insert-receiving pocket for receiving a cutting insert.

2. The tool holder according to claim 1, wherein the clamp includes a top surface and a bottom surface opposite the top surface, the top surface having a front portion and a rear portion formed at an angle with respect to the front portion.

3. The tool holder according to claim 2, wherein the clamp further includes a pair of opposing side walls and an arcuate-shaped rear wall (68) connecting the side walls, and a slot is formed in the side walls to allow the front portion to act as a cantilevered member.

4. The tool holder according to claim 1, wherein the insert-receiving pocket is formed by a pair of side walls and a corner radius therebetween, the side walls formed at an angle with respect to each other, depending on a shape of the cutting insert.

5. The tool holder according to claim 1, wherein the seating surface includes a threaded insert screw-receiving bore for receiving an insert screw and a threaded clamp screw-receiving bore for receiving a first clamp screw, the insert screw-receiving bore formed at an angle with respect to the insert screw-receiving bore.

6. The tool holder according to claim 5, wherein the clamp includes a screw-receiving bore for receiving a second clamp screw and a clamp screw-receiving bore 4(-)-y⁻for receiving the first clamp screw.

7. The tool holder according to claim 6, wherein the second clamp screw is received in the insert screw, thereby causing the clamp to press against the cutting insert to securely hold the cutting insert in the insert-receiving pocket of the clamp.

8. The tool holder according to claim 1, wherein the seating surface includes a pin-receiving bore for receiving a pin for properly locating the clamp on the clamp seating surface of the body.

9. A tool holder comprising:
a body having a forward end with a clamp seating surface; and
a clamp mounted on the clamp seating surface and having an integrated insert-receiving pocket for receiving a cutting insert, the insert-receiving pocket formed by a pair of side walls formed at an angle with respect to each other, the clamp further including a pair of opposing side walls and a slot is formed in the side walls to allow a front portion of the clamp to act as a cantilevered member,
wherein the seating surface includes a threaded insert screw-receiving bore for receiving an insert screw and a threaded clamp screw-receiving bore for receiving a first clamp screw, the insert screw-receiving bore formed at an angle with respect to the insert screw-receiving bore, and
wherein the clamp includes a screw-receiving bore for receiving a second clamp screw and a clamp screw-receiving bore for receiving the first clamp screw and
wherein the second clamp screw is received in the insert screw, thereby causing the front portion of the clamp to press against the cutting insert to securely hold the cutting insert in the insert-receiving pocket of the clamp.

10. A method of assembling a tool holder, comprising:
mounting a clamp with an integrated insert-receiving pocket on a clamp seating surface of a body of the tool holder such that a clamp screw-receiving bore of the clamp is substantially aligned with a clamp screw-receiving bore in the body and a screw-receiving bore in the clamp is substantially aligned with an insert screw-receiving bore in the body;
threading a clamp screw into the clamp screw-receiving bore in the body of the tool holder;
positioning a cutting insert between the clamp seating surface of the body and the clamp such that the cutting insert resides within the insert-receiving pocket of the clamp;
threading an insert screw into the insert screw-receiving bore in the body, thereby causing the cutting insert to be pulled toward the insert-receiving pocket of the clamp; and
threading a clamp screw into the insert screw, thereby causing the clamp to firmly engage the cutting insert and securely holding the cutting insert in the insert-receiving pocket of the clamp.
